(19) United States
(12) Patent Application Publication
(10) Pub. No.: US 2021/0137309 A1
(43) Pub. Date: May 13, 2021

(54) AUTOMATIC COOKING APPARATUS

(71) Applicant: CENZ Automation Co. Ltd., New Taipei City (TW)

(72) Inventors: Chi Chang, Taoyuan City (TW); Yin-Chu Pan, New Taipei City (TW); Yu-Lun Huang, New Taipei City (TW); Hsing-Hsien Chen, New Taipei City (TW)

(73) Assignee: CENZ Automation Co. Ltd., New Taipei City (TW)

(21) Appl. No.: 16/706,786

(22) Filed: Dec. 8, 2019

(30) Foreign Application Priority Data
Nov. 11, 2019 (TW) 108140794

(51) Int. Cl. A47J 36/32; A47J 37/10

(52) U.S. Cl. CPC A47J 36/32; A47J 2201/00; A47J 37/10

(57) ABSTRACT

An automatic cooking apparatus includes a food material supplying module, at least one cookware module, a food material moving mechanism, a liquid seasoning module, a storage unit and a control module. The food material supplying module includes at least one food material container set which includes at least one food material container adapted to contain a food material. The cookware module includes at least one cookware and at least one corresponding heat source, and the heat source is adapted to heat the cookware. The food material moving mechanism is adapted to move the food material in the food material container into the cookware. The liquid seasoning module is adapted to provide a liquid seasoning into the cookware. The storage unit is adapted to store a cooking database. The control module is adapted to control the automatic cooking apparatus to cook the food material according to the cooking database.

### CROSS-REFERENCE TO RELATED APPLICATION

This application claims the priority benefit of Taiwan application no. 108140794, filed on Nov. 11, 2019. The entirety of the above-mentioned patent application is hereby incorporated by reference herein and made a part of this specification.

### BACKGROUND OF THE INVENTION

### Field of the Invention

The disclosure relates to a cooking apparatus, and in particular, to an automatic cooking apparatus.

### Description of Related Art

With the advancement of technologies, many new-generation automation apparatuses have gradually been able to be practically applied in people's common consumption. In addition, due to changes in eating habits, an increasingly high proportion of people eat outside. Therefore, the future development of an automatic cooking apparatus should not be underestimated. However, in the traditional restaurant management mode, labor costs are also increasing, and a dish cooked by a chef often varies excessively in taste. Moreover, many automatic cooking apparatuses are currently operated semi-automatically and require manually placing a required food material in a fixed container in advance, placing the fixed container beside the semi-automatic cooking apparatus, and manually inputting a dish name to the semi-automatic cooking apparatus to obtain a cooking instruction, and then a dish is cooked using automatic procedures through stir-frying. Currently, this type of machine has many disadvantages. For example, for each dish, human labor is required to find out a name of the dish on a small tablet screen, which is time-consuming and is also likely to result in an error in dish selection, and each time, a food material container set of only one dish may be placed on the machine, which reduces efficiency of continuous automation. For this type of automatic cooker, human labor is required to place a required food material in the corresponding food material container in the food material container set. If a wrong food material is placed, the food material is placed into a wrong food material container, or insufficient or excessive food materials are placed, the dish will fail. All current machines have no inspection and warning mechanism. In order to perform automatic cooking with the least human labor while ensuring the quality of a dish, a set of automatic cooking system with improved mechanism design and artificial intelligence is required. However, there is no such cooking system in the market at present.

An automatic cooking apparatus in the market is provided with only one wok, and a dish requiring more cookwares cannot be cooked. For example, cooking of Italian pasta requires a wok for stir-frying food materials and ingredients, and further requires a hot water pot for cooking spaghetti. After the spaghetti is half cooked, the spaghetti is put into the wok for stir-frying with a food material in the wok until the dish is finished. For many Chinese dishes, frying of some ingredients is also required first, and then the ingredients are put into a wok for stir-frying together with other food materials. Therefore, cooking of such dishes requires a wok and an oil pot. Certainly, for some dishes, some food materials need to be blanched, and some food materials need to be fried, and then the food materials are put into a wok for stir-frying together with other food materials. Therefore, cooking of such dishes requires a wok and a hot water pot. If the automatic cooking machine is further provided with a hot water pot and an oil pot in addition to the wok, it is difficult to come up with a design that enables the food material to fully automatically move between the food material container and the cookwares. Therefore, the current automatic cooking apparatus in the market is configured with no oil pot and hot water pot.

### SUMMARY OF THE INVENTION

The invention provides an automatic cooking apparatus capable of automatically executing a corresponding cooking procedure for each to-be-cooked dish.

The automatic cooking apparatus in the invention includes a food material supplying module, a cookware module, a food material moving mechanism, a liquid seasoning module, a storage unit, and a control module. The food material supplying module includes at least one food material container set. The food material container set includes at least one food material container adapted to contain a food material. The cookware module includes at least one cookware and at least one corresponding heat source. The heat source is adapted to heat the cookware. The food material moving mechanism is adapted to move the food material in the food material container into the cookware. The liquid seasoning module is adapted to provide a liquid seasoning into the cookware. The storage unit is adapted to store a cooking database. The control module is adapted to control the automatic cooking apparatus to cook the food material according to the cooking database.

In an embodiment of the invention, the food material supplying module includes a sensing and pairing system. The sensing and pairing system is adapted to sense a dish name corresponding to the food material container set to enable a corresponding recipe in the cooking database. The control module is adapted to control the automatic cooking apparatus according to the corresponding recipe.

In an embodiment of the invention, the sensing and pairing system includes an optical sensor adapted to sense the dish name corresponding to the food material container set.

In an embodiment of the invention, the optical sensor includes an image capturing device adapted to capture an image of identification information on the food material container set.

In an embodiment of the invention, the optical sensor includes an image capturing device adapted to capture an image of the food material in the food material container.

In an embodiment of the invention, the sensing and pairing system includes a warning unit. When the image of the food material in the food material container captured by the image capturing device does not match the corresponding recipe, the warning unit issues a warning.

In an embodiment of the invention, the optical sensor includes a laser code reader adapted to read identification information on the food material container set.

In an embodiment of the invention, the sensing and pairing system includes a weight sensor adapted to measure a weight of the food material container and the food material in the food material container.

In an embodiment of the invention, the sensing and pairing system includes a warning unit. When the weight of the food material container and the food material in the food material container measured by the weight sensor does not match the corresponding recipe, the warning unit issues a warning.

In an embodiment of the invention, the cookware includes a wok and at least one auxiliary cookware. The auxiliary cookware has a basket for containing the food material. The food material moving mechanism is adapted to place the food material in the food material container into the wok and the auxiliary cookware and place the food material in the basket in the auxiliary cookware into the wok.

In an embodiment of the invention, the food material moving mechanism includes a multi-axis robotic arm. The multi-axis robotic arm is adapted to move the food material container to above the wok and pour the food material in the food material container into the wok, move the food material container to above the auxiliary cookware and pour the food material in the food material container into the basket, and move the basket to above the wok and pour the food material in the basket into the wok.

In an embodiment of the invention, the food material moving mechanism includes a set of linear motion robotic arm. The linear motion robotic arm is adapted to move the food material container to above the wok and pour the food material in the food material container into the wok, move the food material container to above the auxiliary cookware and pour the food material in the food material container into the basket, and move the basket to above the wok and pour the food material in the basket into the wok.

In an embodiment of the invention, the auxiliary cookware includes at least one of a hot water pot and an oil pot.

In an embodiment of the invention, the at least one cookware includes a plurality of cookwares. The cookwares include a wok and at least two auxiliary cookwares. The two auxiliary cookwares include a hot water pot and an oil pot. The two auxiliary cookwares have a basket for containing the food material.

In an embodiment of the invention, there is a plurality of food material container sets. After controlling the automatic cooking apparatus to cook the food material in one of the food material container sets, the control module is adapted to control the automatic cooking apparatus to cook the food material in another one of the food material container sets.

In an embodiment of the invention, the food material supplying module includes a carrying structure. The carrying structure includes a plurality of carrying platforms sequentially arranged along a vertical direction, and the carrying platforms are adapted to respectively carry the food material container sets.

In an embodiment of the invention, the food material moving mechanism includes a set of linear motion robotic arm. The linear motion robotic arm is adapted to move the food material container of any one of the food material container sets to above the wok and pour the food material in the food material container into the wok, move the food material container of any one of the food material container sets to above the auxiliary cookware and pour the food material in the food material container into the basket, and move the basket to above the wok and pour the food material in the basket into the wok.

In an embodiment of the invention, the food material supplying module includes a carrying mechanism. The food material container set is adapted to be loaded at a loading position on the carrying mechanism and sequentially moved downward from the loading position to a material taking position and a recycling position along a vertical direction through driving of the carrying mechanism.

In an embodiment of the invention, the automatic cooking apparatus includes a weight sensor. The weight sensor is disposed between the loading position and the material taking position and adapted to be moved to below the food material container set along a horizontal direction through driving of the carrying mechanism.

In an embodiment of the invention, the food material supplying module includes a carrying mechanism. The food material container set is adapted to be carried at a loading position on the carrying mechanism and moved from the loading position to a material taking position along a horizontal direction through driving of the carrying mechanism.

In an embodiment of the invention, the food material supplying module includes a recycling track, and the food material container set is adapted to be moved from the material taking position to a recycling position along the recycling track.

Based on the foregoing, the automatic cooking apparatus in the invention stores the cooking database including a plurality of dish recipes in the storage unit, and the control module may control, according to a recipe corresponding to a particular dish in the cooking database, the automatic cooking apparatus to automatically cook the corresponding food material provided by the food material supplying module. Therefore, a cooking instruction does not need to be manually input. Accordingly, an operation process of the automatic cooking apparatus can be simplified to achieve true fully automatic cooking.

### BRIEF DESCRIPTION OF THE DRAWINGS

FIG. 1 is a perspective view of an automatic cooking apparatus according to an embodiment of the invention.

FIG. 2 is a block diagram of a portion of members of the automatic cooking apparatus in FIG. 1.

FIG. 3 is a perspective view of a portion of members of the automatic cooking apparatus in FIG. 1.

FIG. 4 is a perspective view of a food material supplying module according to another embodiment of the invention.

FIG. 5 is a perspective view of a food material supplying module according to another embodiment of the invention.

FIG. 6A to FIG. 6E are operation process views of the food material supplying module in FIG. 5.

FIG. 7A to FIG. 7E are operation process views of a food material moving mechanism of an automatic cooking apparatus according to another embodiment of the invention.

### DESCRIPTION OF THE EMBODIMENTS

FIG. 1 is a perspective view of an automatic cooking apparatus according to an embodiment of the invention. Referring to FIG. 1, an automatic cooking apparatus 100 in the present embodiment includes a base 100a, a food material supplying module 110, a cookware module 120, a food material moving mechanism 130, and a liquid seasoning module 160. The food material supplying module 110 is configured on the base 100a and includes at least one food material container set 112 (a plurality of food material container sets are shown). Each of the food material container sets 112 includes at least one food material container 112a (a plurality of food material containers are shown). Each of the food material containers 112a is adapted to contain a food material. In particular, each food material container set 112 corresponds to one type of dish, and a plurality of food material containers 112a of the food material container set 112 is respectively configured to contain different food materials required to cook the dish.

The cookware module 120 is configured on the base 100a and includes at least one cookware (a plurality of cookwares 122a, 122b, and 122c are shown) and at least one corresponding heat source (a heat source 124a corresponding to the cookware 122a is shown). The cookwares 122a, 122b, and 122c are respectively, for example, a wok, a hot water pot, and an oil pot. The heat source 124a is configured to heat the wok. The hot water pot and the oil pot are also respectively provided with corresponding heat sources for heating. The hot water pot and the oil pot may be considered as auxiliary cookwares, and are configured to blanch and/or fry a food material according to a required cooking procedure before the food material enters the wok for stir-frying. The hot water pot and the oil pot respectively have baskets 122b1 and 122c1 for containing food materials.

The food material moving mechanism 130 is configured on the base 100a and is adapted to move a food material in the food material container 112a into the cookwares 122a, 122b, and 122c, and is adapted to move food materials in the baskets 122b1 and 122c1 into the cookware 122a. The liquid seasoning module 160 is configured on the base 100a and is adapted to provide a liquid seasoning into the cookware 122a. In particular, the liquid seasoning module 160 includes a plurality of liquid seasoning storage tanks 162. The liquid seasoning storage tanks 162 are respectively configured to store different liquid seasonings, such as salad oil, soy sauce, vinegar, sesame oil, wine, water, and the like, and the liquid seasoning storage tank 162 may provide a liquid seasoning into the cookware 122a during cooking through an appropriate pipeline.

FIG. 2 is a block diagram of a portion of members of the automatic cooking apparatus in FIG. 1. The automatic cooking apparatus 100 in the present embodiment further includes a storage unit 140 and a control module 150. The storage unit 140 is adapted to store a cooking database. The cooking database includes a plurality of recipes corresponding to a plurality of dishes. The storage unit 140 and the control module 150 may be included in a computer device integrated on the base 100a or coupled to the members on the base 100a in other forms. No limitation is imposed on this in the invention. The control module 150 may control, according to a cooking parameter and a procedure of a dish randomly selected through tapping from the cooking database, the automatic cooking device 100 to automatically cook a corresponding food material provided by the food material supplying module 110. Currently, before an automatic cooking machine in the market cooks each dish, a food material container assembly needs to be placed by human on the machine, and then a name of the dish is selected by human through tapping on a tablet screen on a front portion of the machine. Then, the machine obtains a cooking parameter and a procedure of the dish. A control module then controls the machine to cook a food material according to the cooking parameter and the procedure. Food material container assemblies of a plurality of dishes cannot be placed at a time, and the machine cannot automatically identify a dish name corresponding to each food material container assembly. Therefore, efficiency of the automatic cooking machine is greatly limited.

The food material supplying module 110 in the present embodiment includes a sensing and pairing system 115 (shown in FIG. 2) that may be mounted at the food material supplying module 110. The sensing and pairing system 115 is adapted to sense a dish name corresponding to the food material container set 112 to enable a corresponding recipe in the cooking database, so that the control module 150 may control the automatic cooking apparatus 100 to cook according to the corresponding recipe.

In the present embodiment, because there is a plurality of food material container sets 112 and the plurality of food material container sets 112 may respectively contain required food materials corresponding to different dishes in advance, the sensing and pairing system 115 of the automatic cooking apparatus 100 can automatically detect a dish corresponding to each food material container set 112. Since no human intervention is required during cooking, immediately after controlling the automatic cooking apparatus 100 to cook a food material in one of the food material container sets 112, the control module 150 may control the automatic cooking apparatus 100 to cook a food material in another one of the food material container sets 112, during which selecting of a name of a second dish by human through tapping is not required. Therefore, the automatic cooking apparatus 100 may continuously cook a plurality of dishes without interruption, thereby improving cooking efficiency of the automatic cooking apparatus 100.

The sensing and pairing system 115 includes an optical sensor 115a adapted to sense the dish name corresponding to the food material container set 112. The optical sensor 115a in the present embodiment may be disposed at a position that is on the base 110a on which the food material supplying module 110 is located and that is corresponding to the food material supplying module 110. In addition, the optical sensor 115a may be designed as needed to be moved to each of the food material container sets 112 using an appropriate driving mechanism, to facilitate sensing of the food material container sets 112 of the food material supplying module 110. For example, the optical sensor 115a may include an image capturing device configured to capture an image of identification information on the food material container set 112. The identification information may be a specific pattern, a text, or other information that may be used for image identification, thereby identifying the dish name corresponding to the food material container set 112. In addition, the image capturing device may also be configured to capture an image of a food material in the food material container 112a to determine whether the food material in the food material container 112a is a correct food material. When the image of the food material in the food material container 112a captured by the image capturing device does not match a corresponding recipe, a warning unit 115b of the sensing and pairing system 115 issues a warning accordingly to notify a user that the food material of the type in the food material container 112a is wrong. In other embodiments, the optical sensor 115a may also include a laser code reader configured to read identification information on the food material container set 112. The identification information is, for example, a bar code or other information that may be read by the laser code reader.

The sensing and pairing system 115 in the present embodiment may further include a weight sensor 115c adapted to measure weights of the food material container 112a and the food material in the food material container 112a. When the weights of the food material container 112a and the food material in the food material container 112a measured by the weight sensor 115c do not match the corresponding recipe, the warning unit 115b issues a warning accordingly to notify the user that the food material of the weight in the food material containers 112a is wrong. The weight sensor 115c may be disposed below the food material containers 112a to facilitate measurement of weights of the food material containers 112a. A manner of configuring the weight sensor is described in more detail in the following embodiment corresponding to FIG. 4.

The food material supplying module 110 and the food material moving mechanism 130 in the present embodiment are described in detail below. FIG. 3 is a perspective view of a portion of members of the automatic cooking apparatus in FIG. 1. Referring to FIG. 1 and FIG. 3, the food material supplying module 110 includes a carrying structure 114. The carrying structure 114 includes a plurality of carrying platforms 114a sequentially arranged along a vertical direction D2. The carrying platforms 114a are adapted to respectively carry the food material container sets 112. In addition, the food material moving mechanism 130 in the present embodiment includes a set of linear motion robotic arm. The linear motion robotic arm includes a fixed component 132, a movable component 134, a movable component 136, and a movable component 138. The fixed component 132 is disposed on the base 110a. The movable component 134 is movably disposed on the fixed component 132 along a horizontal direction D1 and is adapted to move along the horizontal direction D1 through driving of a drive element 134a (for example, a motor). The movable component 136 is movably disposed on the movable component 134 along a vertical direction D2 and is adapted to move along the vertical direction D2 through driving of a drive element 136a (for example, a motor). The movable component 138 is movably disposed on the movable component 136 along another horizontal direction D3 perpendicular to both the horizontal direction D1 and the vertical direction D2 and is adapted to move along the horizontal direction D3 through driving of a drive element 138a (for example, a motor), and an end of the movable component 138 has a holding structure 138b.

Through movement of the movable component 134, the movable component 136, and the movable component 138 respectively along the horizontal direction D1, the vertical direction D2, and the horizontal direction D3, the holding structure 138b may reach a position adapted to hold the food material containers 112a and hold the food material container 112a. The holding structure 138b is adapted to move the food material container 112a of any one of the food material container sets 112 from the food material container set 112 to above the cookware 122a, and the holding structure 138b may perform overturn through driving of an appropriate drive element (for example, a motor) to pour the food material in the food material container 112a into the cookware 122a. The holding structure 138b is adapted to move the food material container 112a of any one of the food material container sets 112 from the food material container set 112 to above the cookware 122b, and the holding structure 138b may perform overturn through driving of an appropriate drive element (for example, a motor) to pour the food material in the food material container 112a into the basket 122b1. The holding structure 138b is adapted to move the food material container 112a of any one of the food material container sets 112 from the food material container set 112 to above the cookware 122c, and the holding structure 138b may perform overturn through driving of an appropriate drive element (for example, a motor) to pour the food material in the food material container 112a into the basket 122c1. The holding structure 138b is adapted to move the basket 122b1 from the cookware 122b to above the cookware 122a, and the holding structure 138b may perform overturn through driving of an appropriate drive element (for example, a motor) to pour the food material in the basket 122b1 into the cookware 122a. The holding structure 138b is adapted to move the basket 122c1 from the cookware 122c to above the cookware 122a, and the holding structure 138b may perform overturn through driving of an appropriate drive element (for example, a motor) to pour the food material in the basket 122c1 into the cookware 122a.

In the above configuration manner, the automatic cooking apparatus 100 can complete movements required for all of the food material containers 112a and the baskets 122b1 and 122c1 using only the set of linear motion robotic arm during cooking. In the present embodiment, the holding structure 138b may hold the food material container 112a by clamping the food material container 112a, extending into a corresponding hole of the food material container 112a, or in another appropriate manner, and may hold the baskets 122b1 and 122c1 in a similar or same manner. No limitation is imposed on this in the invention. In addition, the holding structure 138b has an overturn function, and may overturn the food material container 112a and the baskets 122b1 and 122c1 to pour the food materials into the cookware 122a below.

A form of the food material supplying module is not limited in the invention, which is exemplified using the following drawings. FIG. 4 is a perspective view of a food material supplying module according to another embodiment of the invention. A food material supplying module 210 shown in FIG. 4 includes a carrying mechanism 214. A food material container set 212 is adapted to be loaded at a loading position P1 on the carrying mechanism 214, and may be sequentially moved downward from the loading position P1 to a material taking position P2 and a recycling position P3 along a vertical direction D2 through driving of the carrying mechanism 214. The food material container set 212 at the material taking position P2 may be slightly moved to an outside of the carrying mechanism 214 along a horizontal direction D1 through driving of the carrying mechanism 214, to help a food material moving mechanism (for example, the food material moving mechanism 130 in the foregoing embodiment or a food material moving mechanism 430 below) hold food material containers 212a in the food material container set 212. The food material container set 212 moved to the recycling position P3 after material taking may be moved away from the carrying mechanism 214 through further driving of the carrying mechanism 214 and is recycled, or a user may directly take away the food material container set 212 at the recycling position P3 for recycling. Driving performed by the carrying mechanism 214 on the food material container set 212 may be achieved using an appropriate drive element, such as a motor, a cylinder, or the like. No limitation is imposed on this in the invention.

In addition, a weight sensor 214c may be further configured in the food material supplying module 210 shown in FIG. 4, and a manner in which the weight sensor 214c acts is similar to that of the weight sensor 115c in the foregoing embodiment, and therefore the descriptions thereof are omitted herein. As shown in FIG. 4, the weight sensor 215c is configured between the loading position P1 and the material taking position P2. In order to enable the weight sensor 215c to measure weights of food material containers 212a at the loading position P1, the weight sensor 215c may be designed to be moved to below the food material container set 212 in a horizontal direction opposite to a horizontal direction D3 through driving of the carrying mechanism 214. Driving performed by the carrying mechanism 214 on the weight sensor 214c may be achieved using an appropriate drive element, such as a motor, a cylinder, or the like. No limitation is imposed on this in the invention. The food material supplying module 210 shown in FIG. 4 may be applied to the automatic cooking apparatus 100 in the foregoing embodiment or an automatic cooking apparatus 400 in the following embodiment. No limitation is imposed on this in the invention.

FIG. 5 is a perspective view of a food material supplying module according to another embodiment of the invention. FIG. 6A to FIG. 6E are operation process views of the food material supplying module in FIG. 5. A food material supplying module 310 in FIG. 5 includes a carrying mechanism 314. A food material container set 312 (shown in FIG. 6A to FIG. 6E) is adapted to be carried at a loading position P1′ on the carrying mechanism 314 and moved from the loading position P1′ to a material taking position P2′ along a horizontal direction D1 through driving of a drive element 314a (for example, a motor) of the carrying mechanism 314, which is shown in FIG. 6A to FIG. 6C. When the food material container set 312 is located at the material taking position P2′, a food material moving mechanism (for example, the food material moving mechanism 130 in the foregoing embodiment or a food material moving mechanism 430 below) may hold food material containers 312a in the food material container set 312.

In addition, the food material supplying module 310 includes a recycling track 316 disposed obliquely. The food material container set 312 after material taking is adapted to be moved from the material taking position P2′ to a recycling position P3′ along the recycling track 316, which is shown in FIG. 6D to FIG. 6E. In the present embodiment, a carrying platform 318 of the food material supplying module 310 carries the food material container set 312 at the loading position P1′, and a drive element 314b of the carrying mechanism 314 is adapted to drive a push rod 314c to push the carrying platform 318, so that the carrying platform 318 is tilted to be engaged with the recycling track 316, which is shown in FIG. 6D. Therefore, the food material container set 312 may be moved from the carrying platform 318 to the recycling track 316. In other embodiments, the food material container set 312 may be moved to the recycling track 316 in other appropriate manners. No limitation is imposed on this in the invention. The food material supplying module 310 shown in FIG. 5 may be applied to the automatic cooking apparatus 100 in the foregoing embodiment or an automatic cooking apparatus 400 in the following embodiment. No limitation is imposed on this in the invention.

A form of the food material moving mechanism is not limited in the invention, which is exemplified using the following drawings. FIG. 7A to FIG. 7E are operation process views of a food material moving mechanism of an automatic cooking apparatus according to another embodiment of the invention. In an automatic cooking apparatus 400 shown in FIG. 7A to FIG. 7E, manners in which a food material supplying module 410, a cookware module 420, cookwares 422a, 422b and 422c, and a hot source 424a are configured and act may be the same as or similar to those of the food material supplying module, the cookware module, the cookwares, and the heat source in the foregoing embodiment. In addition, the automatic cooking apparatus 400 may include a storage unit, a control module, and a liquid seasoning module the same as or similar to those in the foregoing embodiment. A main difference between the automatic cooking apparatus 400 and the automatic cooking apparatus 100 lies in that the food material moving mechanism 430 includes a multi-axis robotic arm. The multi-axis robotic arm includes a movable component 432. The movable component 432 may rotate along a rotation axis A through driving of an appropriate drive element (for example, a motor), and may rise/fall in a direction parallel to the rotation axis A through driving of an appropriate drive element (for example, a motor or a cylinder). In this way, as shown in FIG. 7A, the movable component 432 may rotate to face the food material supplying module 410, so as to hold a food material container 412a of the food material supplying module 410 using a holding portion 432a of the movable component 432. The movable component 432 may rise, which is shown in FIG. 7B, and may rotate to above the cookware 422c, which is shown in FIG. 7C, or may rotate to above the cookware 422a, which is shown in FIG. 7D, or may rotate to above the cookware 422b, which is shown in FIG. 7E. The movable component 432 above the cookware 422a, 422b, or 422c may overturn the food material container 412a in an appropriate manner (for example, drive the holding part 432a to rotate) to pour a food material in the food material container 412a into the cookware 422a, a basket 422b1, or a basket 422c1. In addition, the movable component 432 may also hold the basket 422b1 or the basket 422c1 using the holding portion 432a of the movable component 432 or in other appropriate manners, move the basket 422b1 or the basket 422c1 to above the cookware 422a, and pour the food material in the basket 422b1 or the basket 422c1 into the cookware 422a. In other embodiments, the food material moving mechanism may be a moving mechanism in other forms. No limitation is imposed on this in the invention.

In conclusion, the automatic cooking apparatus in the invention may automatically find out the cooking parameter and the procedure of the dish stored in the storage unit by automatically identifying the name of the dish corresponding to the food material container set, and the control module may control, according to the cooking parameter and procedure, the automatic cooking apparatus to automatically cook the corresponding food material provided by the food material supplying module. Therefore, the dish name does not need to be manually input. Accordingly, an operation process of the automatic cooking apparatus can be simplified to achieve true fully automatic cooking. In addition, image capturing and weight sensing are further performed to determine whether the food material of the type in the food material container is correct, so that cooking quality of the automatic cooking apparatus can be improved. Furthermore, in addition to a common wok, the automatic cooking apparatus further includes an oil pot and a hot water pot, so that the automatic cooking apparatus have more improved and comprehensive cooking functions.

What is claimed is:

1. An automatic cooking apparatus, comprising:
a food material supplying module comprising at least one food material container set, wherein the at least one food material container set comprises at least one food material container, and the at least one food material container is adapted to contain a food material;
a cookware module comprising at least one cookware and at least one corresponding heat source, wherein the at least one heat source is adapted to heat the at least one cookware;
a food material moving mechanism adapted to move the food material in the at least one food material container into the at least one cookware;
a liquid seasoning module adapted to provide a liquid seasoning into the at least one cookware;
a storage unit adapted to store a cooking database; and
a control module adapted to control the automatic cooking apparatus to cook the food material according to the cooking database.

2. The automatic cooking apparatus according to claim 1, wherein the food material supplying module comprises a sensing and pairing system, the sensing and pairing system is adapted to sense a dish name corresponding to the at least one food material container set to enable a corresponding recipe in the cooking database, and the control module is adapted to control the automatic cooking apparatus according to the corresponding recipe.

3. The automatic cooking apparatus according to claim 2, wherein the sensing and pairing system comprises an optical sensor adapted to sense the dish name corresponding to the at least one food material container set.

4. The automatic cooking apparatus according to claim 3, wherein the optical sensor comprises an image capturing device adapted to capture an image of identification information on the at least one food material container set.

5. The automatic cooking apparatus according to claim 3, wherein the optical sensor comprises an image capturing device adapted to capture an image of the food material in the at least one food material container.

6. The automatic cooking apparatus according to claim 5, wherein the sensing and pairing system comprises a warning unit, and when the image of the food material in the at least one food material container captured by the image capturing device does not match the corresponding recipe, the warning unit issues a warning.

7. The automatic cooking apparatus according to claim 3, wherein the optical sensor comprises a laser code reader adapted to read identification information on the at least one food material container set.

8. The automatic cooking apparatus according to claim 2, wherein the sensing and pairing system comprises a weight sensor adapted to measure a weight of the at least one food material container and the food material in the at least one food material container.

9. The automatic cooking apparatus according to claim 8, wherein the sensing and pairing system comprises a warning unit, and when the weight of the at least one food material container and the food material in the at least one food material container measured by the weight sensor does not match the corresponding recipe, the warning unit issues a warning.

10. The automatic cooking apparatus according to claim 1, wherein the at least one cookware comprises a plurality of cookwares, the cookwares comprise a wok and at least one auxiliary cookware, and the at least one auxiliary cookware comprises a basket configured to contain the food material, wherein the food material moving mechanism is adapted to place the food material in the food material container into the wok and the at least one auxiliary cookware, and is further adapted to place the food material in the basket in the at least one auxiliary cookware into the wok.

11. The automatic cooking apparatus according to claim 10, wherein the food material moving mechanism comprises a multi-axis robotic arm, and the multi-axis robotic arm is adapted to move the at least one food material container to above the wok and pour the food material in the at least one food material container into the wok, is adapted to move the at least one food material container to above the at least one auxiliary cookware and pour the food material in the at least one food material container into the basket, and is adapted to move the basket to above the wok and pour the food material in the basket into the wok.

12. The automatic cooking apparatus according to claim 10, wherein the food material moving mechanism comprises a set of linear motion robotic arm, and the set of linear motion robotic arm is adapted to move the at least one food material container to above the wok and pour the food material in the at least one food material container into the wok, is adapted to move the at least one food material container to above the at least one auxiliary cookware and pour the food material in the at least one food material container into the basket, and is adapted to move the basket to above the wok and pour the food material in the basket into the wok.

13. The automatic cooking apparatus according to claim 10, wherein the at least one auxiliary cookware comprises at least one of a hot water pot and an oil pot.

14. The automatic cooking apparatus according to claim 1, wherein the at least one cookware comprises a plurality of cookwares, and the cookwares comprise a wok and at least two auxiliary cookwares, wherein the at least two auxiliary cookwares comprise a hot water pot and an oil pot, and the at least two auxiliary cookwares comprise a basket configured to contain the food material.

15. The automatic cooking apparatus according to claim 1, wherein the at least one food material container set comprises a plurality of food material container sets, wherein after controlling the automatic cooking apparatus to cook the food material in one of the food material container sets, the control module is adapted to control the automatic cooking apparatus to cook the food material in another one of the food material container sets.

16. The automatic cooking apparatus according to claim 15, wherein the food material supplying module comprises a carrying structure, the carrying structure comprises a plurality of carrying platforms sequentially arranged along a vertical direction, and the carrying platforms are adapted to respectively carry the food material container sets.

17. The automatic cooking apparatus according to claim 16, wherein the food material moving mechanism comprises a set of linear motion robotic arm, and the set of linear motion robotic arm is adapted to move the at least one food material container of any one of the food material container sets to above the wok and pour the food material in the at least one food material container into the wok, is adapted to move the at least one food material container of any one of the food material container sets to above the at least one auxiliary cookware and pour the food material in the at least one food material container into the basket, and is adapted to move the basket to above the wok and pour the food material in the basket into the wok.

18. The automatic cooking apparatus according to claim 1, wherein the food material supplying module comprises a carrying mechanism, and the at least one food material container set is adapted to be loaded at a loading position on the carrying mechanism and sequentially moved downward from the loading position to a material taking position and a recycling position along a vertical direction through driving of the carrying mechanism.

19. The automatic cooking apparatus according to claim 18, comprising a weight sensor disposed between the loading position and the material taking position, and the weight sensor is adapted to be moved to below the at least one food material container set along a horizontal direction through driving of the carrying mechanism.

20. The automatic cooking apparatus according to claim 1, wherein the food material supplying module comprises a carrying mechanism, and the at least one food material container set is adapted to be carried at a loading position on the carrying mechanism and moved from the loading position to a material taking position along a horizontal direction through driving of the carrying mechanism.

21. The automatic cooking apparatus according to claim 20, wherein the food material supplying module comprises a recycling track, and the at least one food material container set is adapted to be moved from the material taking position to a recycling position along the recycling track.
